(19) United States
(12) Patent Application Publication
(10) Pub. No.: US 2003/0037250 A1
(43) Pub. Date: Feb. 20, 2003

(54) System and method for securely accessing data on content servers using dual encrypted paths from a central authorization host

(75) Inventors: James D. Walker, Dallas, TX (US); Alexander F. Webb, Arlington, TX (US); Gregory J. Feigel, Bedford, TX (US); James J. Lavin, Plano, TX (US)

Correspondence Address: NOVAKOV DAVIS & MUNCK, A PROFESSIONAL CORPORATION, 900 THREE GALLERIA TOWER, 13155 NOEL ROAD, DALLAS, TX, 75240, US

(73) Assignee: DoodleBug Online, Inc., Dallas, TX (US)

(21) Appl. No.: 09/895,830

(22) Filed: Jun. 29, 2001

(51) Int. Cl. H04L 9/00

(52) U.S. Cl. 713/200; 380/270

(57) ABSTRACT

There is disclosed a secured access controller for use in connection with a network that communicates with content servers that store content objects and client processing systems that request access to the stored content objects. The secured access controller comprises: 1) a database for storing a plurality of encryption keys and a plurality of decoding keys associated with selected ones of the content servers and the client processing systems; and 2) an encryption controller for receiving from a first one of the client processing systems an access request for a first selected one of the content objects stored on a first one of the content servers and, in response thereto, generating a first encryption key and transmitting the first encryption key to the first client processing system, wherein the first encryption key is usable by the first client processing system to encrypt client messages transmitted to the secured access controller.

### CROSS-REFERENCE TO RELATED APPLICATIONS

The present invention is related to those disclosed in U.S. patent application:

1. Ser. No. 09/256,872, filed on Feb. 24, 1999, entitled “SYSTEM AND METHOD FOR AUTHORIZING ACCESS TO DATA ON CONTENT SERVERS IN A DISTRIBUTED NETWORK”; and

2. Ser. No. 09/664,580, filed on Sep. 18, 2000, entitled “SYSTEM AND METHOD FOR ACCESSING DATA ON CONTENT SERVERS VIA A CENTRAL AUTHORIZATION HOST.”

The above applications are commonly assigned to the assignee of the present invention. The disclosures of the related patent applications are hereby incorporated by reference for all purposes as if fully set forth herein.

### TECHNICAL FIELD OF THE INVENTION

The present invention is directed, in general, to an application for viewing selected content on a wide area network accessible to the general public and, more specifically, to a central authorization host that uses dual encrypted data paths to control access to content objects stored on content servers on a public network.

### BACKGROUND OF THE INVENTION

The Internet is a wide area network that links together many thousands of smaller sub-networks. These sub-networks are owned by different businesses, government entities, universities, and other organizations. The information, or content, on these sub-networks is accessible to outside parties by means of the World Wide Web (or “W3” or “Web”). The Web comprises software, standardized protocols, and other widely-accepted conventions that enable a computer user (or client) to browse (or navigate) through the vast amounts of data content distributed among the host computer(s) (or server(s)) in each of the sub-networks.

The content on the Web is organized into web sites. Each web site is a collection of text data files, graphical data files, and multimedia (e.g., audio/video) data files belonging to, and controlled by, a single business, governmental body, university, non-profit organization, etc. A web site comprises one or more web pages that contain the text, graphics and multimedia content that a computer user reads, views, and/or hears. The primary web page of each web site is referred to as a “home page” and each web page is identified by a Uniform Resource Locator (or “URL”). A URL is the electronic equivalent of an Internet address.

There are a number of browser applications available that enable a computer user to browse (or “surf”) the Web. These browsers may run on a variety of computer platforms. However, the most popular platforms are personal computers (PCs) that use WINDOWS™ or MACINTOSH™ operating systems. Two of the better-known browser applications are NETSCAPE™ and MICROSOFT INTERNET EXPLORER™. Browser applications use simple mouse and keyboard controls to make it easy to locate and to move between web sites and to view and to download content stored at web sites. A PC user may access a web site by typing the URL of the web site into a special window on the browser screen. A PC user also may jump from a first web site to a second web site by selecting (or “clicking”) a link on a web page in the first web site. The link automatically accesses the URL of the second web site without requiring the user to type the URL into a dedicated window. A user also may access web sites by means of searching software (or “search engine”) that locates web sites that match search criteria selected by the user.

The features of the Web and the advanced capabilities of browsers combine to make surfing the Web a relatively user friendly experience. As a result, there has been an explosion in the number of persons that access the Web. There has been a correspondingly large increase in the number and variety of web sites on the Internet.

While ease of use and variety of content are two of the primary attractions of the World Wide Web, these advantages also are accompanied by drawbacks. Since Web sites are separately owned and controlled by independent entities, the content that may be readily accessed from each web site is determined almost entirely by the owner of the web site. Many web sites contain content that many people find offensive, including text and images that may be obscene, pornographic, racist, graphically violent, or the like. A PC user may inadvertently access offensive material by carelessly selecting a URL link for an unfamiliar web site while browsing on another, inoffensive web site. The PC user may also accidently access an offensive web site that is found by a search engine.

This problem is even more acute when the PC user is a child. Many parents are unwilling to allow their children to browse the Web without supervision because of the unknown content of many web sites. But the problem is by no means limited to children. Many businesses attempt to limit access to web sites that may be deemed offensive to employees and/or customers. One goal of employer restrictions is to prevent sexual harassment lawsuits based in whole or in part on claims of a hostile work environment caused by one or more employees browsing through pornographic web sites in full view of other offended employees. Another goal of these restrictions is to prevent employees from wasting valuable work time browsing on non-work related web sites, whether or not the non-work related web sites contain offensive materials. Other organizations, such as public libraries, also attempt to limit access to offensive web sites for a variety of reasons.

A number of solutions have been offered to filter (i.e., censor) offensive web sites. Filtering software products, such as SurfWatch, Cyberpatrol, Cybersitter, and NetNanny, use one or more techniques to prevent a child from accessing offensive materials. Some filters look for key words on a targeted web site, such as “sex,” “nude,” “porn,” “erotica,” “death,” “dead,” “bloody,” “cocaine,” “crack,” “drug(s),” and the like, and block access to the web site. Unfortunately, these filters frequently block access to inoffensive web sites in which a key word is used in a harmless manner (e.g., “Don't use drugs”) or is embedded in an otherwise innocuous word (e.g., “Essex” or “Animal Crackers”).

Some filters include a database of forbidden web sites that operates in conjunction with a browser. The filter prevents the browser from accessing any site found in the database. The filter usually can be updated on-line to stay current with offensive data bases. Unfortunately, it is exceedingly difficult, if not impossible, to create and to maintain a comprehensive data base of offensive sites, especially when many web sites frequently and deliberately change their URLs in order to avoid being blocked by the filtering software. Additionally, filtering software places the decision regarding which web sites are inappropriate for a child in the hands of someone other than the child's parents. What may be inoffensive to the designer of the filtering software may still be offensive to some parents, and vice versa.

More generally, a business may want to make content objects stored on content servers available to selected users, including both employees and non-employees, under tightly controlled circumstances. The term “content objects” is intended very broadly and may include text documents, application programs, audio files, video files, and web page data. The content objects may or may not be owned by the business and may be dispersed among a number of geographically separated content servers. Quite frequently, these objects are only accessible by remotely located employees and non-employees through a public wide area network, such as the Internet.

A business may want to make a content object, such as a document or a web site, available to an employee in only one version, and only for a limited time period. If the content object is changed in any way, the business may wish to deny access to any previously authorized person until after the employee has been re-authorized. This may be true whether the content object is owned by the business or by a third party. Additionally, since much of the communication traffic that access a content object on a content server may occur on public networks, a business may want to hide network traffic that accesses the content object from unauthorized users.

Therefore, there is a need for improved systems and methods for restricting access to content objects on content servers in a data network. More particularly, there is a need for an access controller that prevents unauthorized persons from monitoring message traffic in a public network that accesses content objects on content servers. More particularly, there is a need for an access controller that prevents unauthorized persons from snooping user names and passwords that may be used to access content on a content server.

### SUMMARY OF THE INVENTION

To address the above-discussed deficiencies of the prior art, it is a primary object of the present invention to provide a secured access controller for use in connection with a network capable of communicating with a plurality of content servers that store content objects and a plurality of client processing systems capable of requesting access to the stored content objects. According to an advantageous embodiment of the present invention, the secured access controller comprises: 1) a database capable of storing a plurality of encryption keys and a plurality of decoding keys associated with selected ones of the plurality of content servers and the plurality of client processing systems; and 2) an encryption controller capable of receiving from a first one of the plurality of client processing systems an access request for a first selected one of the content objects stored on a first one of the plurality of content servers and, in response thereto, generating a first encryption key and transmitting the first encryption key to the first client processing system, wherein the first encryption key is usable by the first client processing system to encrypt client messages transmitted to the secured access controller.

According to one embodiment of the present invention, the encryption controller is further capable of generating a corresponding first decoding key capable of decoding the encrypted client messages.

According to another embodiment of the present invention, the encryption controller is capable of receiving from the first client processing system a first client encryption key, wherein the encryption controller uses the first client encryption key to encrypt secured access controller messages transmitted to the first client processing system.

According to still another embodiment of the present invention, the encryption controller is further capable of generating a second encryption key and transmitting the second encryption key to the first content server, wherein the second encryption key is usable by the first content server to encrypt content server messages transmitted to the secured access controller.

According to yet another embodiment of the present invention, the encryption controller is further capable of generating a corresponding second decoding key capable of decoding the encrypted content server messages.

According to a further embodiment of the present invention, the encryption controller is capable of receiving from the first content server a first content server encryption key, wherein the encryption controller uses the first content server encryption key to encrypt secured access controller messages transmitted to the first content server.

According to a still further embodiment of the present invention, the encryption controller, in response to the access request, is capable of requesting and receiving from the first client processing system a second client encryption key and transmitting the second client encryption key to the first content server, wherein the second client encryption key is usable by the first content server to encrypt content server messages transmitted to the first client processing system.

According to a yet further embodiment of the present invention, the encryption controller, in response to the access request, is capable of requesting and receiving from the first content server a second content server encryption key and transmitting the second content server encryption key to the first client processing system, wherein the second content server encryption key is usable by the first client processing system to encrypt client messages transmitted to the first content server.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an exemplary network architecture in which a browser system in accordance with the principles of the present invention may be implemented;

FIG. 2 illustrates the exemplary computer system in FIG. 1 in greater detail;

FIG. 3 illustrates in greater detail an exemplary personal computer (PC) capable of executing a browser application in accordance with the principles of the present invention;

FIG. 4 illustrates a flow diagram which depicts the installation and start-up operations in the exemplary computer system of a browser application in accordance with one embodiment of the present invention;

FIG. 5 illustrates an exemplary user data table in the disk storage of the exemplary computer system according to one embodiment of the present invention;

FIG. 6 illustrates a flow diagram, which depicts the parent (supervisor) operating mode of the exemplary browser application in accordance with one embodiment of the present invention;

FIG. 7 illustrates a flow diagram, which depicts the child (employee) operating mode of the exemplary browser application in accordance with one embodiment of the present invention;

FIG. 8 illustrates selected portions of the exemplary network architecture in which a central authorization host is used to authorize access to content servers according to one embodiment of the present invention; and

FIG. 9 is a flow diagram 900 illustrating the operation of a web site authorization server acting as a central authorization host according to one embodiment of the present invention.

### DETAILED DESCRIPTION

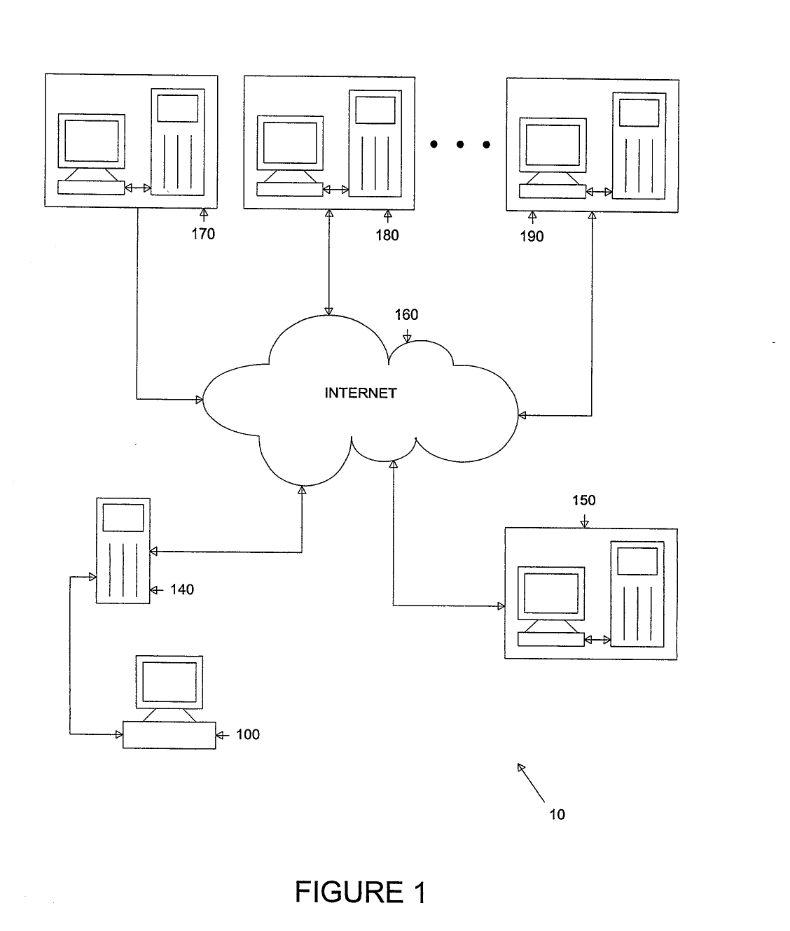

FIGS. 1 through 9, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged personal computer, mainframe computer, web server, client/server architecture, or broader computer network.

Referring initially to FIG. 1, there is illustrated exemplary network architecture 10 in which a browser system in accordance with the principles of the present invention may be implemented. Network architecture 10 comprises exemplary computer system 100, which may be, for example, a personal computer (PC), Internet service provider (ISP) server 140, web site authorization server 150, and wide area data communications network 160 (generally referred to hereafter as “Internet 160”). Network architecture 10 also comprises content server 170, content server 180, and content server 190.

A browser application in accordance with the principles of the present invention is installed on computer system 100. The browser application allows a user of computer system 100 to browse web sites hosted on content servers 170, 180, and 190. Each of content servers 170, 180, and 190 comprises one or more network server devices capable of interacting through Internet 160 with remote client devices, including computer system 100. Computer system 100 is coupled to Internet 160 via ISP server 140 and receives standard Internet services, such as e-mail, from ISP server 140.

One or more of the web sites hosted on each of content servers 170, 180, and 190 may contain content that is offensive to some people, that is unsuitable for children, or that is unnecessary for an employee to use in performing his or her job. As will be described below in greater detail, the browser application on computer system 100, by itself or in conjunction with web site authorization server 150, restricts access to all web sites on content servers 170, 180, and 190 except those that are specifically authorized by a parent (or supervisor) operating computer system 100. After a web site has been authorized for access, a child (or employee) may subsequently access that web site from computer system 100.

In the descriptions that follow, computer system 100 is illustrated and described in terms of an exemplary personal computer (PC) device. However, those skilled in the art will understand that the principles of the present invention are not limited to browser applications in a personal computing environment. The described embodiment of computer system 100 is by way of example only. In fact, the present invention may be implemented on or in conjunction with any suitable computer processing environment, including multi- and parallel processing environments, mainframe computers, super computers, groups of networked computers, hand-held minicomputers, such as PALMPILOT™ digital devices, and the like.

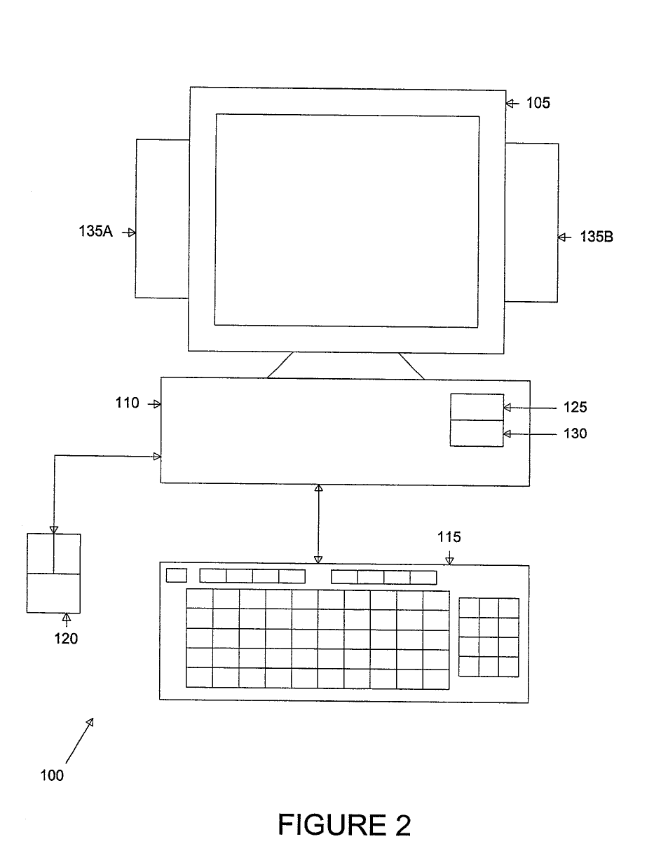

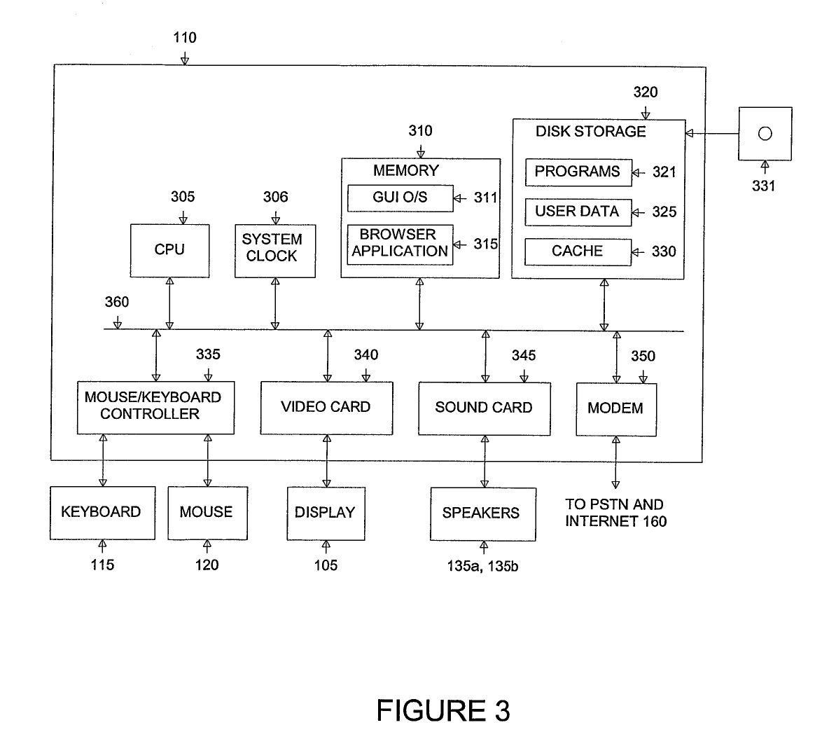

FIG. 2 illustrates exemplary computer system 100 in greater detail. Computer system 100 comprises display device (or monitor) 105, personal computer (PC) 110, within which are various electronic components (discussed with reference to FIG. 3), keyboard 115, mouse 120, and speakers 135a and 135b. Display device 105, keyboard 115 and mouse 120 cooperate to allow communication between computer system 100 and a user (not shown). PC 110 comprises dedicated hardware reset switch 125 and power switch 130. Reset switch 125 is adapted to trigger hardware reset circuitry (not shown) within PC 110 to reboot or restart PC 110 when the user depresses reset switch 125. Power switch 130 is capable of interrupting and restoring power to PC 110. The interruption and restoration of power brings about a restart of PC 110.

Display device 105 provides a screen area for display of graphical data under the control of an exemplary graphical user interface (“GUI”) operating system (O/S) and browser application executing within PC 110. The exemplary GUI operating system manages division of computer resources among various application tasks executing in PC 110. The GUI operating system may divide the screen of display device 105 into a plurality of suitably arranged windows that display data corresponding to each of the application tasks. Each window may suitably be allowed to occupy a portion or an entirety of the screen of display device 105, depending on the user's wishes. Various ones of the windows may suitably occlude one another, whether in whole or in part.

FIG. 3 illustrates in greater detail exemplary personal computer (PC) 110 capable of executing a browser application in accordance with the principles of the present invention. PC 110 comprises central processing unit (CPU) 305, system clock 306, and memory 110, which typically comprises volatile RAM memory capable of storing browser application 315 during execution by CPU 305. According to an advantageous embodiment of the present invention, memory 310 is also used to store GUI O/S 311, which may comprise, for example, one or more of: WINDOWS® NT, WINDOWS® 95, WINDOWS® 98, UNIX®, HPUX, AIX, or similar conventional operating systems.

PC 110 also comprises disk storage device 320. Disk storage device 320 is representative of one or more readable and/or writeable fixed storage devices, such as a PC hard drive, and/or removable storage devices capable of receiving removable storage media 331, which may comprise, for example, a floppy disk, a ZIP disk, a CD-ROM disk, a DVD disk, etc. In an advantageous embodiment of the present invention, removable storage media 331 may be used to store browser application 315 and load it into computer system 100.

Disk storage device 320 contains programs 321, user data table 325, and cache 330. Programs 321 is storage space used to store applications executed by CPU 305, including copies of GUI O/S 311 and browser application 315. User data table 325 stores user IDs, user passwords, and user preference information about one or more users of computer system 100. In an advantageous embodiment of the present invention, user data table 325 stores lists of authorized URLs identifying selected web pages that have already been approved by a supervisor (or parent) using computer system 100. Cache 330 is used by browser application to cache data from web pages when a user of PC 110 browses the Web.

PC 110 also comprises mouse/keyboard controller 335, video care 340, sound card 345, and modem 350. The various components of PC 110 transfer data and control signals across bus 360. The user inputs data and commands to PC 110 via mouse/keyboard controller 335, which provides an interface between keyboard 115 and mouse 120 and CPU 305. Modem 350 provides a communication interface between PC 110 and the publicly switched telephone network (PSTN) and Internet 160. The GUI operating system of PC 110 transfers browser application screens and web page images to display device 105 via video card 340. Any audio files that are played by browser application 315 are transferred to speakers 135a and 135b via sound card 345.

Conventional computer system architecture is more fully discussed in THE INDISPENSABLE PC HARDWARE BOOK, by Hans-Peter Messmer, Addison Wesley (2nd ed. 1995) and COMPUTER ORGANIZATION AND ARCHITECTURE, by William Stallings, MacMillan Publishing Co. (3rd ed. 1993); conventional computer and communications network design is more fully discussed in DATA NETWORK DESIGN, by Darren L. Spohn, McGraw-Hill, Inc. (1993); conventional data communication is more fully discussed in VOICE AND DATA COMMUNICATIONS HANDBOOK, by Bud Bates and Donald Gregory, McGraw-Hill, Inc. (1996); DATA COMMUNICATIONS PRINCIPLES, by R. D. Gitlin, J. F. Hayes and S. B. Weinstein, Plenum Press (1992); and THE IRWIN HANDBOOK OF TELECOMMUNICATIONS, by James Harry Green, Irwin Professional Publishing (2nd ed. 1992). Each of the foregoing publications is incorporated herein by reference for all purposes.

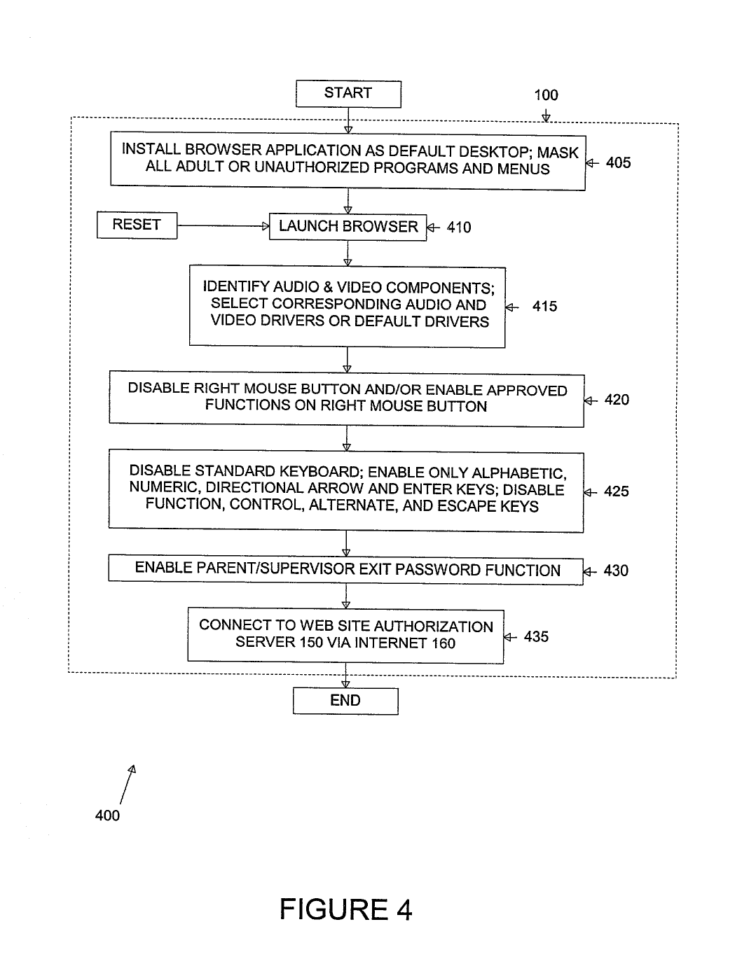

FIG. 4 illustrates flow diagram 400, which depicts the installation and start-up operations in computer system 100 of browser application 315 in accordance with one embodiment of the present invention. Upon installation, browser application 315 replaces the existing desktop and becomes the default desktop whenever computer system 100 is restarted. All adult or unauthorized programs, icons, and menus are masked (process step 405). At this point, only browser application 315 may be launched.

After installation is complete or a reset (i.e., power is switched OFF, then ON) has occurred, browser application 315 is automatically launched (process step 410). Optionally, an icon for browser application 315 may be placed on the default desktop so that the user may select when to run browser application 315. Browser application 315 identifies the audio and video devices in computer system 100 and selects corresponding video and audio drivers, or default drivers, as the case may be (process step 415). Next, browser application 315 disables the right mouse button and/or enables approved functions only on the right mouse button (process step 420). Next, browser application 315 may disable the standard keyboard buttons and enable only selected alphabetic and numeric keys, direction arrows, and the ENTER key. Browser application 315 also may disable the function (F1 through F12) keys, the CONTROL key(s), the ALT key(s), and the ESCAPE key (process step 425). The reconfiguration and/or disabling of the mouse and keyboard prevent an employee user (or a child user) from attempting to bypass browser application 315.

If browser application 315 is being set up for the first time, browser application 315 next enables a supervisor (or parent) exit password function. A random password is generated for a supervisor (or parent) to use to exit browser application 315 and return computer system 100 to its normal configuration and standard GUI O/S 311 desktop and interface. Without the password, a child user or employee user cannot exit browser application 315 (process 430). At this point, computer system 100 will remain in browser application 315 and, if re-booted, will automatically return to browser application 315.

To finish the installation/launch operation, browser application 315 automatically connects to web site authorization server 150 via Internet 160. This is accomplished by automatically dialing up and connecting to ISP server 140 or by searching for an existing connection to ISP server 140 in the case of a cable modem connection, a digital subscriber line (DSL) connection, or a local area network (LAN) connection (process step 435).

Computer system 100 operates in one of two operating modes under control of browser application 315: supervisor (or parent) mode or employee (or child) mode. In supervisor (parent) mode, browser application 315 functions like a standard browser in that any web site may be accessed by browser application 315 without restriction. The supervisor (parent) selects acceptable web sites and adds them to a database of authorized web sites that the employee (child) may visit. Later, during employee (child) mode, browser application 315 permits the employee (child) to access only those web sites that appear in the database of authorized web sites. Before explaining the operation of supervisor mode and employee mode in greater detail, the database of authorized web sites generated by browser application 315 under control of the supervisor (parent) will be discussed.

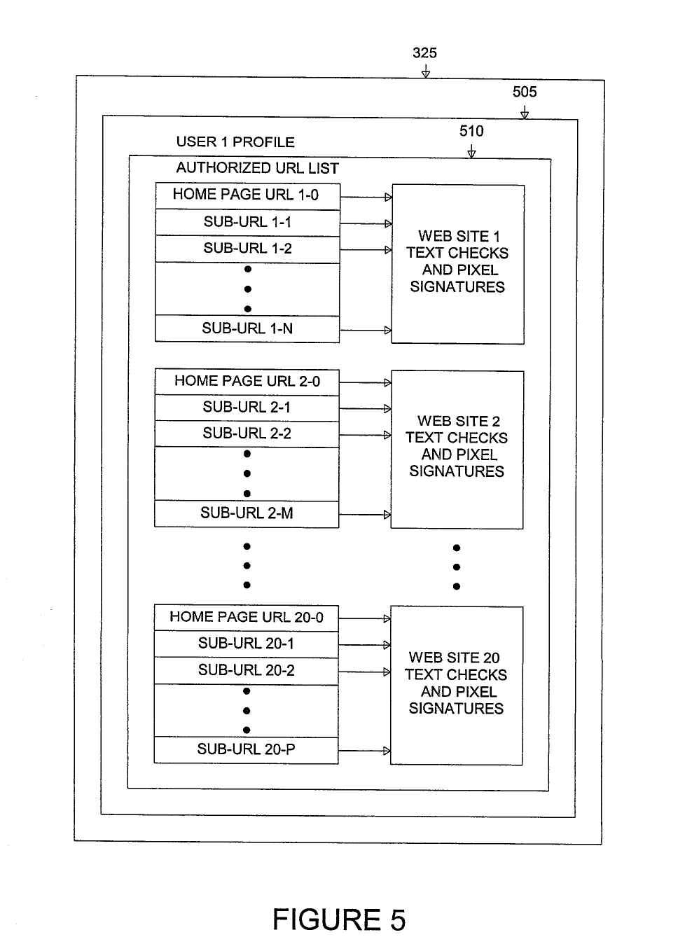

FIG. 5 illustrates exemplary user data table 325 according to one embodiment of the present invention., User data table 325 contains a user profile table for each user of computer system 100, including exemplary user profile table 505 (hereafter referred to as “User 1 Profile”). User 1 Profile comprises, among other things, authorized URL list 510, which contains correlated lists of web pages that have been approved by a supervisor (parent) for viewing by an employee (child). In the illustrated example, web pages from twenty (20) web sites have been approved and are stored in authorized URL list 510.

A plurality of web pages from an exemplary web site, referred to as Web Site 1, are stored in authorized URL list 510. The primary web page (or home page) of Web Site 1 is stored in memory as Home Page URL 1-0. Subsequent web pages associated with Web Site 1 are stored as Sub-URL 1-1, Sub-URL 1-2, . . . Sub-URL 1-m. Each authorized web page has associated therewith one or more modification indicators (or data verification values) stored in an array labeled “Web Site 1 Text Checks and Pixel Signatures.” When a web page is first approved and downloaded by a supervisor (or parent), browser application 315 generates a unique identifier for each graphic image (i.e., JPEG file, GIF file, Bitmap file, etc.), text file, or other element in the web page. The unique identifiers serve as modification indicators in that browser application 315 uses them to determine if graphics or text in subsequently downloaded web pages have been modified.

The unique identifiers for graphic images are called “pixel signatures” and are generated by applying a unique algorithm to a few randomly selected pixels in the graphic image file. If the value of a pixel signature is different when a web page is subsequently downloaded by an employee, browser application 315 may occlude the graphic image or refuse to display the web page at all. Similarly, browser application 315 generates unique identifiers for text data, background (or wall paper) patterns, and other elements that form the web page in order to detect changes that occur subsequent to approval of the web page.

In the case of a child, browser application 315 does not allow any modified element of a web page to be displayed to the child until after a parent has re-approved the web page. In this manner, a parent has complete control over the web sites that a child may access. The child cannot browse any web pages that a parent has not approved and subsequent changes to an approved web page are rejected or occluded by browser application 315 until after the change has been re-approved by the parent. When the parent approves of the changes, the web pages in authorized URL list 510 are correspondingly updated. This prevents a child from viewing inappropriate material on a web site, whether the offensive matter is added by the web site owner or is maliciously inserted by an outsider.

In the case of an employee, it is not as important to prevent the employee from seeing offensive material as it is in the case of a child. Relatively speaking, it is more important to prevent an employee from browsing non-work related web sites, whether or not offensive. Browser application 315 gives a supervisor the option of allowing access only to individual web pages at a selected web site or to the entire web site en masse once the supervisor has determined that the web site is work-related. Similarly, browser application 315 may occlude any subsequently changed elements of a web page at a supervisor's option, although this is relatively less important than it is in the case of a child.

In an advantageous embodiment of the present invention, browser application 315 is installed with an initial pre-approved list of suitable (i.e., child-appropriate or work-related URLs) in authorized URL list 510. Alternatively, the initial pre-approved list of suitable URLs may be downloaded from web site authorization server 150. This enables a supervisor (parent) to avoid starting from scratch in building a database of suitable URLs. The supervisor (parent) still has the option of deleting the initial pre-approved URLs, if so desired. Furthermore, browser application 315 periodically “pings” web site authorization server 150, which may respond by transferring to browser application 315 software correction updates, additional suitable URLS, etc.

While the user data table 325 was illustrated resident on disk storage device 320 in FIG. 3, those skilled in the computer arts will understand that the same may be maintained remotely in alternate embodiments, such as at the website authorization server 150. In yet further embodiments, the data table may be distributed across multiple storage devices or computer systems.

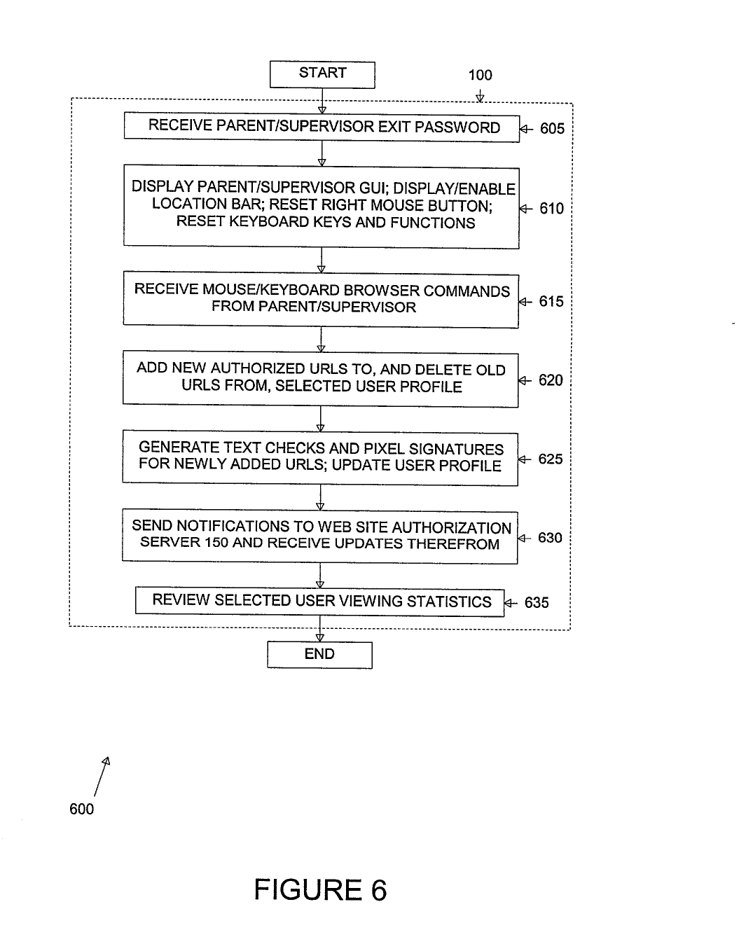

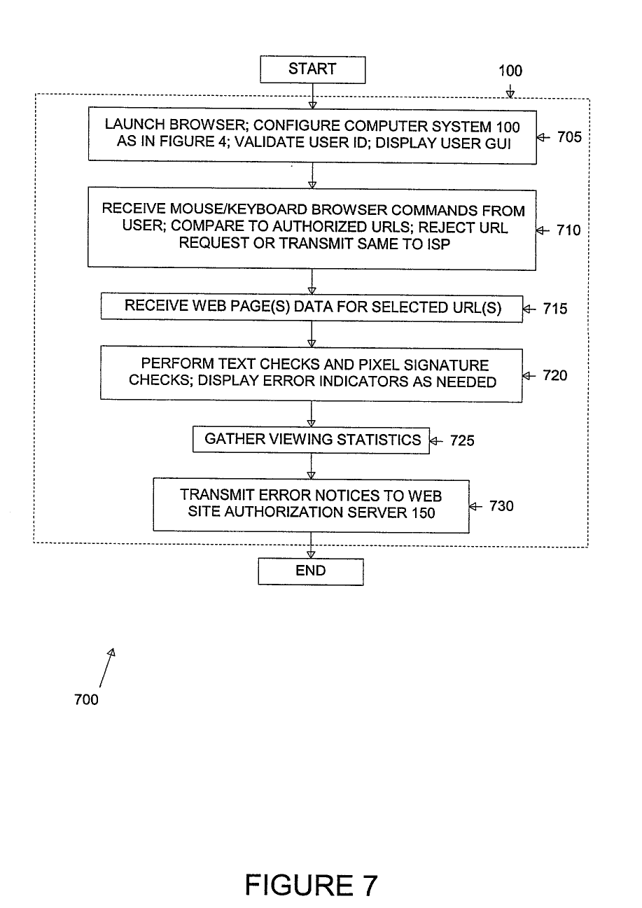

FIG. 6 illustrates flow diagram 600, which depicts the supervisor (parent) operating mode of browser application 315 in accordance with one embodiment of the present invention. Initially, browser application 315 is in employee (child) operating mode, described below in greater detail in connection with FIG. 7, when a supervisor (parent) enters the supervisor (parent) exit password (process step 605). In response, browser application 315 modifies the limited GUI display used by the employee (child) to a more complete supervisor (parent) GUI display. In an advantageous embodiment, browser application 315 inserts or re-enables a location bar on the GUI display so that the parent may type a target URL location into the location bar. Browser application 315 also resets the right mouse button and the keyboard to standard configurations that enable the supervisor (parent) to perform functions and access web sites that are forbidden to an employee (child) user (process step 610). At this point, the parent or supervisor optionally may quit (or exit) browser application 315 and return computer system 100 to its standard graphical user interface and software application configuration.

Next, browser application 315 receives mouse and/or keyboard commands and data as the parent (or supervisor) begins to browse the Web (process step 615). From time to time, browser application 315 adds new authorized URLs to a selected user profile in response to point-and-click commands received from the supervisor (parent) GUI display. Similarly, browser application 315 may also delete existing authorized URLs from a selected user profile in response to point-and-click commands received from the supervisor (parent) GUI display (process step 620). As new URLs are added and old URLs are deleted by the supervisor (parent), browser application 315 generates selected text checksums and pixel signatures for the text and graphic elements that make up each authorized web page (process step 625).

In an advantageous embodiment of the present invention, the supervisor (parent) may send e-mail notifications to web site authorization server 150 and receive updates from it (process step 630). The notifications sent by a parent may include suggestions regarding new child-appropriate web sites that the parent has found and which may be added to the database maintained by web site authorization server 150. The notifications sent to web site authorization server 150 also may include warnings regarding web sites that have been changed to contain offensive material or web sites that have been closed down. The updates received from web site authorization server 150 may include correction “patches” to repair errors in browser application 315. The update also may include lists of new URLs that are appropriate for children.

Finally, the supervisor (parent) may review selected user viewing statistics gathered by browser application 315 (process step 635). In an advantageous embodiment of the present invention, browser application 315 may use system clock 306 to record the amount of time that an employee (child) spends reviewing selected URL pages. The supervisor (parent) may optionally send these viewing statistics to web site authorization server 150.

FIG. 7 illustrates flow diagram 700, which depicts the employee (child) operating mode of browser application 315 in accordance with one embodiment of the present invention. Initially, browser application 315 is launched by starting or re-booting computer system 100. Browser application 315 configures computer system 100, as described above in connection with FIG. 4. Optionally, browser application 315 may prompt the child or employee to enter a user name and user ID in order to verify his or her identity and to select a corresponding user profile from user data table 325. After verification, browser application 315 displays a graphical user interface corresponding to the user. Alternatively, browser application 315 may omit the identity verification step and simply display a standard employee (child) graphical user interface (process step 705).

When the initial set-up routine is complete, browser application 315 receives browser commands from the user in the form of mouse and keyboard inputs. The user initially clicks on screen icons designating broad category groups and is led to subsequent screen menus and icons identifying increasingly narrow topics. When a suitably narrow topic area has been selected, icons linking directly to selected pre-authorized URLs are displayed on the screen. Alternatively, the user may be allowed to type a specific URL into a screen window. The URL selected by the employee (child) is then compared to the most recently updated list of authorized web sites on in authorized URL list 510. If the URL that is “clicked” or typed in by the user is not in, or is no longer in, authorized URL list 510, browser application 315 rejects the request and displays an error indication on the screen. However, if the URL selected by the user is in authorized URL list 510, browser application 315 sends the request to ISP server 140 (process step 710).

ISP server 140 then retrieves the selected web page from one or more of content servers 170, 180 or 190 and forwards the web page to browser application 315 (process step 715). Next, browser application 315 verifies that the text and/or graphic images contained in the received web page have not been modified since the web page was last approved by the supervisor (parent). This is done by generating check sums and pixel signatures for the received text and graphic images and comparing the results with the corresponding check sums and pixel signatures stored in authorized URL list 510. If a mismatch occurs, browser application 315 does not display the text and/or graphic image. Instead, browser application 315 substitutes an “error” indication, such as a paint-ball splotch, a stop sign, a blackened box, or the like, and records the error in user data table 325. Subsequently, a supervisor (parent) may view the web page on which the mismatch occurred and, if the changed test or image is inoffensive, re-authorize the newly updated web page (process step 720).

In the background, browser application 315 may gather viewing statistics on the child or employee. For example, browser application 315 may use system clock 306 to record the amount of time the employee (child) spends on each web site and each web page. Browser application 315 also may use system clock 306 to record the amount of time between mouse clicks and/or key strokes, thereby measuring the amount of idle time when the employee (child) is not operating browser application 315 (process step 725). In an advantageous embodiment of the present invention, browser application 315 may transmit to web site authorization server 150 information about changed graphics or text on authorized web pages or about web sites that are no longer valid (process step 730). This enables the operator of web site authorization server 150 to augment and to improve the database of suitable appropriate web sites stored in web site authorization server 150.

In the above-described embodiments of the present invention, most of the functions performed by browser application 315 are executed in computer system 100. While these embodiments may have certain speed and/or security advantages, this is by no means a necessary condition for implementing the present invention. In alternate embodiments, some or even all of the functions performed by browser application 315 may be distributed among other processing nodes in exemplary network architecture 10, as was discussed with reference to FIG. 5, for instance. In particular, many of the functions performed by browser application 315 may be executed in web site authorization server 150. Additionally, the authorized web site database and user profile information used by browser application 315 may be stored in web site authorization server 150. In such a configuration, computer system 100 essentially acts as a dummy terminal controlled by browser application 315 in web site authorization server 150.

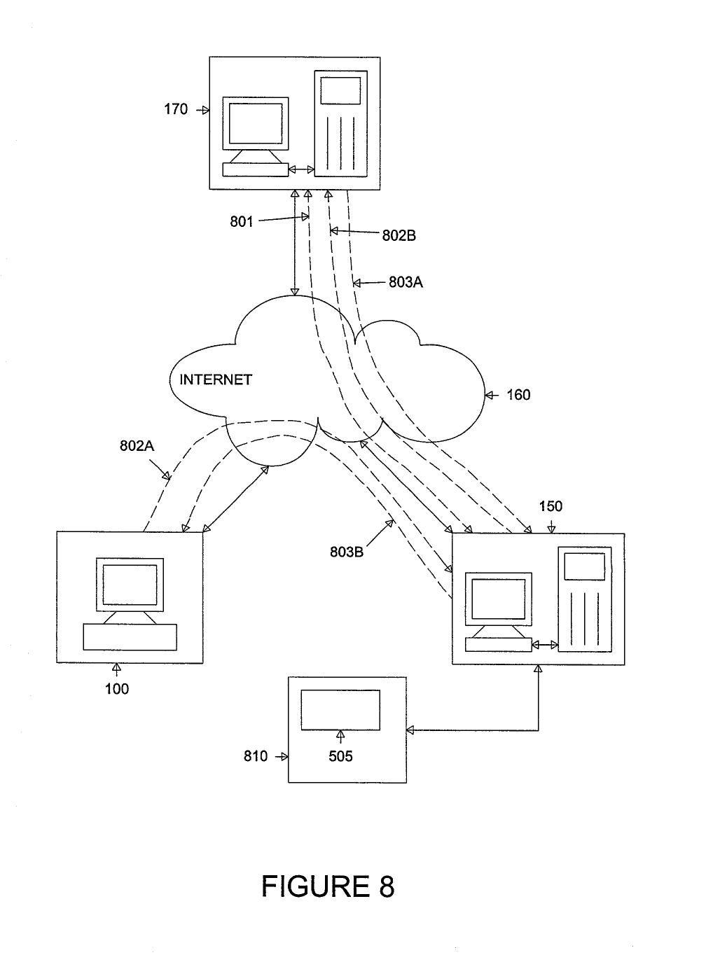

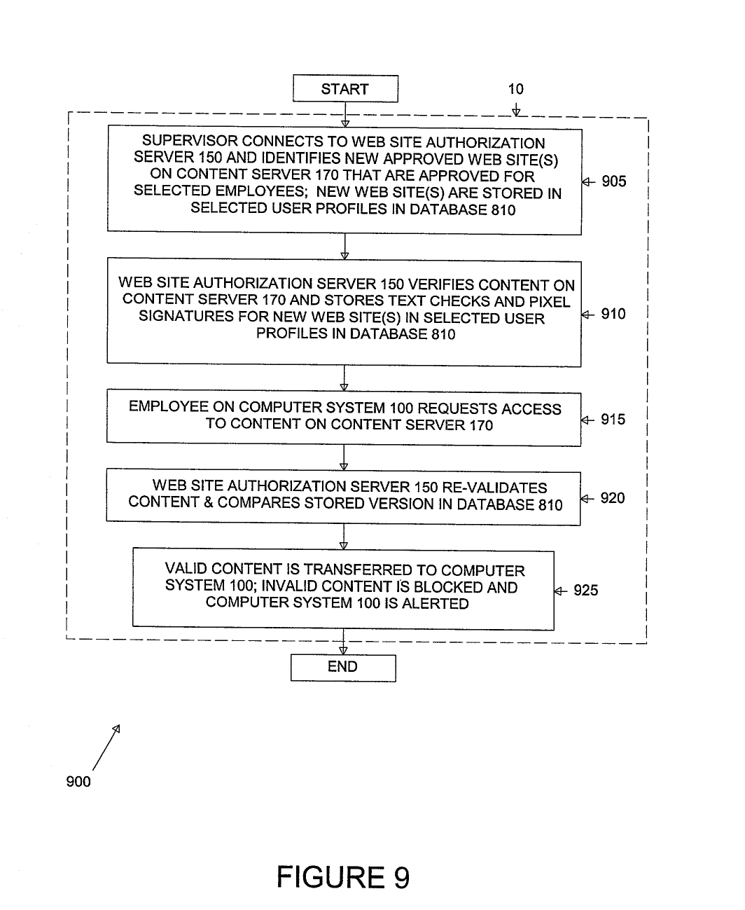

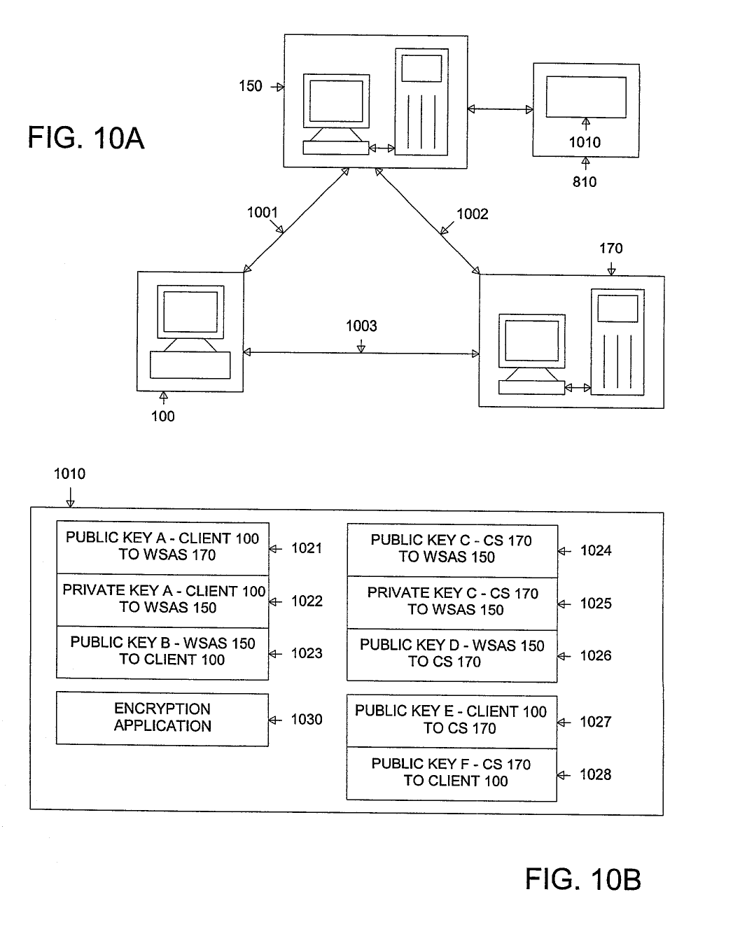

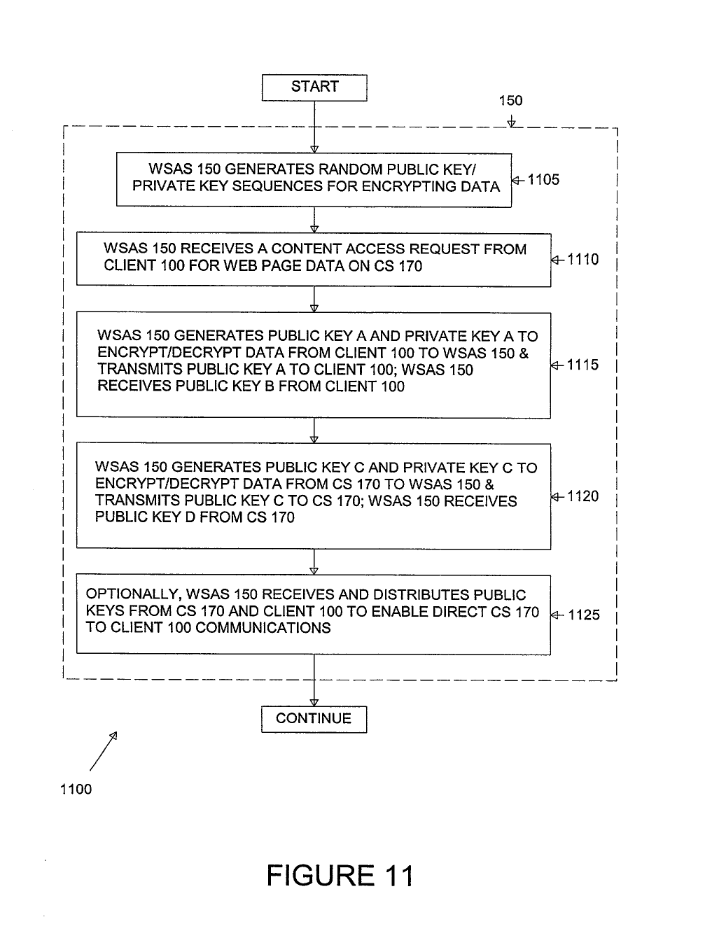

FIG. 8 illustrates selected portions of exemplary network architecture 10 in which a central authorization host is used to authorize access content on content servers according to one embodiment of the present invention. Here, “content” is very broadly defined and includes not merely web page data, but also documents, video files, audio files, application programs, and the like. Web site authorization server 150 and database 810 serve as the central authorization host and stores authorized web site information, authorized document information, authorized application program information, user profile information, and the like, that are used to control access to content on exemplary content server 170 by an employee using computer system 100. FIG. 9 depicts flow diagram 900, which illustrates the operation of web site authorization server 150 as a central authorization host according to one embodiment of the present invention.

Initially, a supervisor connects to web site authorization server 150 through Internet 160 from a remote client device, such as computer system 100, as indicated by logical communication path 801. Once the supervisor is validated by means of a user name and password, the supervisor identifies (i.e., enters URL data) one or more new web sites or Internet addresses of, for example, FTP sites that store documents on content server 170 that are approved for one or more selected employees. Web site authorization server 150 then stores the approved web site and Internet address information in selected user profiles in user profile table 505 in database 810 (process step 905).

Next, web site authorization server 150 verifies the content of the newly approved web site(s) selected by the supervisor by downloading web pages from the selected sites and generating one or more of text check values, character redundancy check (CRC) values, longitudinal redundancy check (LRC) values, and pixel signature values, as described above. These values are then stored in the corresponding selected user profiles in user profile table 505 in database 810 (process step 910).

At some later point in time, an employee using computer system 100 may request web site authorization server 150 to access and retrieve content from content server 170, as indicated by logical communication path 802A (process step 915). In response to the access request, web site authorization server 150 requests and retrieves from content server 170 the requested web pages and/or documents requested by the employee, as indicated by logical communication paths 802B and 803A. Web sit authorization server 150 then re-validates the content by again calculating the appropriate text check values, character redundancy check (CRC) values, longitudinal redundancy check (LRC) values, and pixel signature values. The newly calculated values are then compared to the previously calculated values stored in database 810 (process step 920). If the retrieved content from content server 170 is value is valid (i.e., unchanged), web site authorization server 150 transmits the content to computer system 100, as indicated by logical communication path 803B. If the content is invalid (i.e., has been changed), web site authorization server 150 blocks transfer of the content to computer system 100 and transmits a message to computer system 100 indicating that access has been denied (process step 925).

According to an advantageous embodiment of the present invention, web site authorization server 150 may provide additional levels of security through the use of encryption to prevent unauthorized persons from intercepting and possibly modifying secure content as the secure content is transferred over a public data network. Web site authorization server 150 accomplishes this through the use of public key-private key encryption and decoding techniques. Public key-private key encryption is well known and understood by those skilled in the art and web site authorization server 150 may employ any one or more of known public key-private key encryption applications. A particular public key may be used to encrypt a data packet, but only the private key that corresponds to that particular public key is capable of decoding the encrypted data. Even an unauthorized user who has a copy of the public key cannot use the public key to decode (or decrypt) the encrypted data.

FIG. 10A illustrates selected portions of exemplary network architecture 10 in which a central encryption host provides security for accessing content on content servers according to one embodiment of the present invention. Again, “content” is very broadly defined and includes not merely web page data, but also documents, video files, audio files, application programs, and the like. Web site authorization server 150 and database 810 serve as the central encryption host and store authorized web site information, authorized document information, authorized application program information, user profile information, and the like, that are used to control access to content on exemplary content server 170 by an employee using computer system 100 (hereafter frequently referred to as “client 100”). Web site authorization server 150 creates secure logical data paths, including secure logical data path 1001 between web site authorization server 150 and client 100 and secure logical data path 1002 between web site authorization server 150 and content server 170. Optionally, web site authorization server 150 may also establish secure logical data path 1003 between client 100 and content server 170.

FIG. 10B illustrates selected portions of memory 1010 in database 810. Memory 1010 stores encryption key records 1021-1028 and encryption application 1030, which is executed by web site authorization server 150. Encryption key record 1021 contains a public key, labeled Public Key A, that encrypts communications from client 100 to web site authorization server 150. Encryption key record 1022 contains the private key, labeled Private Key A, that corresponds to Public Key A and that is used to decode encrypted communications from client 100 to web site authorization server 150. Encryption key record 1023 contains the public key, labeled Public Key B, that encrypts communications from web site authorization server 150 to client 100. Public Key B is generated by client 100 and transmitted to web site authorization server 150. Client 100 retains the corresponding Private Key B that decodes communications from web site authorization server 150. Together, Public Key A, Public Key B, Private Key A, and Private Key B create secure logical data path 1001.

Encryption key record 1024 contains a public key, labeled Public Key C, that encrypts communications from content server (CS) 170 to web site authorization server 150. Encryption key record 1025 contains the private key, labeled Private Key C, that corresponds to Public Key C and that is used to decode encrypted communications from content server 170 to web site authorization server 150. Encryption key record 1025 contains the public key, labeled Public Key D, that encrypts communications from web site authorization server 150 to content server 170. Public Key D is generated by content server 170 and transmitted to web site authorization server 150. Content server 170 retains the corresponding Private Key D that decodes communications from web site authorization server 150. Together, Public Key C, Public Key D, Private Key C, and Private Key D create secure logical data path 1002.

In an advantageous embodiment of the present invention, web site authorization server 150 may optionally provide for direct communications between content server 170 and client 100. In such an embodiment, web site authorization server 150 requests that content server 170 and client 100 transmit public keys to web site authorization server 150 for distribution. Encryption key record 1027 contains the public key, labeled Public Key E, that encrypts communications from client 100 to content server 170. Public Key E is generated by client 100 and transmitted to web site authorization server 150 via secure logical data path 1001. Web site authorization server 150 then distributes Public Key E to content server 170 via secure logical data path 1002. Client 100 retains the corresponding Private Key E that decodes communications from content server 170 to client 100.

Similarly, encryption key record 1028 contains the public key, labeled Public Key F, that encrypts communications from content server 170 to client 100. Public Key F is generated by content server 170 and transmitted to web site authorization server 150 via secure logical data path 1002. Web site authorization server 150 then distributes Public Key F to client 100 via secure logical data path 1001. Content server 170 retains the corresponding Private Key F that decodes communications from client 100 to content server 170. Together, Public Key E, Public Key F, Private Key E, and Private Key F create secure logical data path 1003.

FIG. 11 depicts flow diagram 1100, which illustrates the operation of web site authorization server 150 and database 810 as a central authorization host according to one embodiment of the present invention. During routine operations, web site authorization server (WSAS) 150 generates pairs of random public key sequences and private key sequences that are used to encrypt secure logical data paths 1001-1003 (process step 1105).

At some point, web site authorization server 150, which is executing encryption application 1030, receives a content access request from, for example, client 100, requesting access to web page data, documents, video files, audio files, application programs, and the like, that are stored on content server (CS) 170 (process step 1110). In response, web site authorization server 150 generates Public Key A and Private Key A to encrypt and decode data from client 100 to web site authorization server 150 and transmits Public Key A to client 100. For the reverse link, web site authorization server 150 receives Public Key B from client 100 (process step 1115).

Similarly, web site authorization server 150 generates Public Key C and Private Key C to encrypt and decode data from content server 170 to web site authorization server 150 and transmits Public Key C to content server 170. For the reverse link, web site authorization server 150 receives Public Key D from content server 170 (process step 1120). Optionally, if web site authorization server 150 permits direct access to content server 170, web site authorization server 150 may request and receive Public Key E from client 100 and Public Key F from content server 170. Web site authorization server 150 distributes Public Key F to client 100 and Public Key E to content server 170 (process step 1125).

For additional security, web site authorization server 150 may periodically generate and distribute new public keys and private keys to client 100 and content server 170. Encryption application 1030 determines the frequency with which the encryption keys are changed. The more frequently the encryption keys are changed, the more secure the communication links are. Thus, web site authorization server 150 prevents unauthorized persons from monitoring message traffic in a public network (such as internet 160) that accesses content objects on content servers 170, 180, and 190. In particular, web site authorization server 150 prevents unauthorized persons from snooping user names and passwords that may be used to access content on content servers 170, 180, and 190.

Although the present invention has been described in detail, those skilled in the art should understand that they can make various changes, substitutions and alterations herein without departing from the spirit and scope of the invention in its broadest form.

What is claimed is:

1. For use in connection with a network capable of communicating with a plurality of content servers that store content objects and a plurality of client processing systems capable of requesting access to said stored content objects, a secured access controller comprising:
a database capable of storing a plurality of encryption keys and a plurality of decoding keys associated with selected ones of said plurality of content servers and said plurality of client processing systems; and
an encryption controller capable of receiving from a first one of said plurality of client processing systems an access request for a first selected one of said content objects stored on a first one of said plurality of content servers and, in response thereto, generating a first encryption key and transmitting said first encryption key to said first client processing system, wherein said first encryption key is usable by said first client processing system to encrypt client messages transmitted to said secured access controller.

2. The secured access controller as set forth in claim 1 wherein said encryption controller is further capable of generating a corresponding first decoding key capable of decoding said encrypted client messages.

3. The secured access controller as set forth in claim 2 wherein said encryption controller is capable of receiving from said first client processing system a first client encryption key, wherein said encryption controller uses said first client encryption key to encrypt secured access controller messages transmitted to said first client processing system.

4. The secured access controller as set forth in claim 3 wherein said encryption controller is further capable of generating a second encryption key and transmitting said second encryption key to said first content server, wherein said second encryption key is usable by said first content server to encrypt content server messages transmitted to said secured access controller.

5. The secured access controller as set forth in claim 4 wherein said encryption controller is further capable of generating a corresponding second decoding key capable of decoding said encrypted content server messages.

6. The secured access controller as set forth in claim 5 wherein said encryption controller is capable of receiving from said first content server a first content server encryption key, wherein said encryption controller uses said first content server encryption key to encrypt secured access controller messages transmitted to said first content server.

7. The secured access controller as set forth in claim 6 wherein said encryption controller, in response to said access request, is capable of requesting and receiving from said first client processing system a second client encryption key and transmitting said second client encryption key to said first content server, wherein said second client encryption key is usable by said first content server to encrypt content server messages transmitted to said first client processing system.

8. The secured access controller as set forth in claim 7 wherein said encryption controller, in response to said access request, is capable of requesting and receiving from said first content server a second content server encryption key and transmitting said second content server encryption key to said first client processing system, wherein said second content server encryption key is usable by said first client processing system to encrypt client messages transmitted to said first content server.

9. A network comprising:
a plurality of content servers that store content objects;
a plurality of client processing systems capable of requesting access to said stored content objects; and
a secured access controller comprising:
a database capable of storing a plurality of encryption keys and a plurality of decoding keys associated with selected ones of said plurality of content servers and said plurality of client processing systems; and
an encryption controller capable of receiving from a first one of said plurality of client processing systems an access request for a first selected one of said content objects stored on a first one of said plurality of content servers and, in response thereto, generating a first encryption key and transmitting said first encryption key to said first client processing system, wherein said first encryption key is usable by said first client processing system to encrypt client messages transmitted to said secured access controller.

10. The network as set forth in claim 9 wherein said encryption controller is further capable of generating a corresponding first decoding key capable of decoding said encrypted client messages.

11. The network as set forth in claim 10 wherein said encryption controller is capable of receiving from said first client processing system a first client encryption key, wherein said encryption controller uses said first client encryption key to encrypt secured access controller messages transmitted to said first client processing system.

12. The network as set forth in claim 11 wherein said encryption controller is further capable of generating a second encryption key and transmitting said second encryption key to said first content server, wherein said second encryption key is usable by said first content server to encrypt content server messages transmitted to said secured access controller.

13. The network as set forth in claim 12 wherein said encryption controller is further capable of generating a corresponding second decoding key capable of decoding said encrypted content server messages.

14. The network as set forth in claim 13 wherein said encryption controller is capable of receiving from said first content server a first content server encryption key, wherein said encryption controller uses said first content server encryption key to encrypt secured access controller messages transmitted to said first content server.

15. The network as set forth in claim 14 wherein said encryption controller, in response to said access request, is capable of requesting and receiving from said first client processing system a second client encryption key and transmitting said second client encryption key to said first content server, wherein said second client encryption key is usable by said first content server to encrypt content server messages transmitted to said first client processing system.

16. The network as set forth in claim 15 wherein said encryption controller, in response to said access request, is capable of requesting and receiving from said first content server a second content server encryption key and transmitting said second content server encryption key to said first client processing system, wherein said second content server encryption key is usable by said first client processing system to encrypt client messages transmitted to said first content server.

17. For use in connection with a network capable of communicating with a plurality of content servers that store content objects and a plurality of client processing systems capable of requesting access to the stored content objects, a method of securely accessing the stored content objects comprising the steps of:
receiving in a central encryption controller an access request transmitted by a first one of the plurality of client processing systems, the access request requesting access to a first selected one of the content objects stored on a first one of the plurality of content servers;
generating in the central encryption controller a first encryption key and transmitting the first encryption key to the first client processing system; and
in the first client processing system, using the first encryption key to encrypt client messages transmitted to the central encryption controller.

18. The method as set forth in claim 17 further comprising the step of generating in the central encryption controller a corresponding first decoding key capable of decoding the encrypted client messages.

19. The method as set forth in claim 18 further comprising the steps of:
receiving in the central encryption controller a first client encryption key transmitted by the first client processing system; and
using the first client encryption key in the central encryption controller to encrypt central encryption controller messages transmitted to the first client processing system.

20. The method as set forth in claim 19 further comprising the steps of:
generating in the central encryption controller a second encryption key and transmitting the second encryption key to the first content server; and
in the first content server using the second encryption key to encrypt content server messages transmitted to the central encryption controller.

21. The method as set forth in claim 20 further comprising the steps of generating in the central encryption controller a corresponding second decoding key capable of decoding the encrypted content server messages.

22. The method as set forth in claim 21 further comprising the steps of:
receiving in the central encryption controller a first content server encryption key transmitted by the first content server; and
using the first content server encryption key in the central encryption controller to encrypt central encryption controller messages transmitted to the first content server.

23. The method as set forth in claim 22 further comprising the steps, in response to the access request, of:
in the central encryption controller, requesting and receiving from the first client processing system a second client encryption key;
transmitting the second client encryption key to the first content server; and
using the second client encryption key in the first content server to encrypt content server messages transmitted to the first client processing system.

24. The method as set forth in claim 23 further comprising the steps, in response to the access request, of:
in the encryption controller requesting and receiving from the first content server a second content server encryption key;
transmitting the second content server encryption key to the first client processing system; and
using the second content server encryption key in the first client processing system to encrypt client messages transmitted to the first content server.
